(19) United States
(12) Patent Application Publication
(10) Pub. No.: US 2016/0042011 A1
(43) Pub. Date: Feb. 11, 2016

(54) PERSONALIZED DESTINATIONS IN NAVIGATION SYSTEMS WITH PASSWORD PROTECTION

(71) Applicant: Panasonic Automotive Systems Company of America, Division of Panasonic Corporation of North America, Peachtree City, GA (US)

(72) Inventor: RENU BALAKRISHNA, SUNNYVALE, CA (US)

(73) Assignee: Panasonic Automotive Systems Company of America, Division of Panasonic Corporation of North America

(21) Appl. No.: 14/818,414

(22) Filed: Aug. 5, 2015

Related U.S. Application Data
(60) Provisional application No. 62/033,140, filed on Aug. 5, 2014.

(51) Int. Cl. G06F 17/30; G06F 21/31

(52) U.S. Cl. CPC G06F 17/30241; G06F 17/30964; G06F 21/31

(57) ABSTRACT

A method of operating a vehicle navigation system includes enabling a user to enter and store in the system a destination address in association with a name and/or telephone number. The user is enabled to enter the name and/or telephone number in free form and without format restrictions. The user is enabled to later retrieve the destination address based on the name and/or telephone number being used as a search term.

### CROSS-REFERENCE TO RELATED APPLICATIONS

This application claims the benefit of U.S. Provisional Application No. 62/033,140, filed on Aug. 5, 2014, which the disclosure of which is hereby incorporated by reference in its entirety for all purposes.

### FIELD OF THE INVENTION

The disclosure relates to a method of electronically storing information about a geographical address.

### BACKGROUND OF THE INVENTION

In current navigation systems, the user is not able to personalize the destinations. For example, if a user has a recurring appointment with a hospital once every two months, then upon each appointment the user may need to remember the address and enter the address to the system manually.

In currently existing GPS/Navigation systems, no destination address can be stored with a name that the user would like. As an example, a user who enters a particular apartment/office address as destination may later want to recollect the same based on a person's name or phone number. In current navigation systems, the user may have to recollect and enter the address manually if the address is not in the lists of recently visited destinations.

Currently, addresses such as apartment addresses cannot be stored in association with a name/phone number in a vehicle navigation system. Also, in current systems, the user may not be able to recognize the exact address of a particular destination (e.g., “my eye hospital that I last went to one month ago”) from a list of recent destinations. This can be especially true if the user has visited a large number of new places in the recent history.

### SUMMARY

The present invention may provide a new way of personalized destinations entry in navigation systems, where the user is able to enter the address with an associated name and/or phone number that is his personal selection. The user may be able to later retrieve the address on the run, based on a name/phone number search. For example, the user may save an apartment address with a friend's name and phone number so that the next time he wants to go to that address he can search for the address in the system with that friend's name/phone number.

This present invention may provide a method of personalized destination entry in a navigation system, so that the user can retrieve any address that he once saved in association with a name and/or phone number. For privacy and safety reasons, this feature can be password enabled after every ignition OFF or parking of the vehicle.

The invention may comprise, in one form thereof, a method of operating a vehicle navigation system, including enabling a user to enter and store in the system a destination address in association with a name and/or telephone number. The user is enabled to enter the name and/or telephone number in free form and without format restrictions. The user is enabled to later retrieve the destination address based on the name and/or telephone number being used as a search term.

The invention may comprise, in another form thereof, a method of operating a vehicle navigation system database, including storing in the system database three elements in association with each other. The three elements include a destination address, a name and a telephone number. A user is enabled to later retrieve any two of the three elements by using the third of the three elements as a search term.

The invention may comprise, in yet another form thereof, a motor vehicle including a processor communicatively coupled to each of an engine ignition, a navigation system database, and a user interface. The processor enables a user, via the user interface, to enter and store in the system database four elements in association with each other. The four elements include a destination address, a name of the destination or of a person located at the destination, a telephone number, and an identity of the user. The user is enabled, via the user interface, to later retrieve any two of a group of three of the elements including the destination address, the name, and the telephone number by using the third of the three elements as a search term. The user must have his identity verified after the vehicle ignition has been turned off before the user is enabled to retrieve any of the three elements.

### BRIEF DESCRIPTION OF THE DRAWINGS

A better understanding of the present invention will be had upon reference to the following description in conjunction with the accompanying drawings.

FIG. 1 is an example screen shot of a user interface in one step of one embodiment of the present invention.

FIG. 2 is an example screen shot of a user interface in another step of an embodiment of the present invention.

FIG. 3 is an example screen shot of a user interface in yet another step of an embodiment of the present invention.

FIG. 4 is an example screen shot of a user interface in still another step of an embodiment of the present invention.

FIG. 5 is an example screen shot of a user interface in a still further step of an embodiment of the present invention.

FIG. 6 is an example screen shot of a user interface in another step of an embodiment of the present invention.

FIG. 7 is an example screen shot of a user interface in yet another step of an embodiment of the present invention.

FIG. 8 is an example screen shot of a user interface in still another step of an embodiment of the present invention.

FIG. 9 is a block diagram of one embodiment of a vehicle of the present invention.

### DETAILED DESCRIPTION OF THE PREFERRED EMBODIMENTS

Glossary

Search Term—a word or other term used to electronically retrieve data, Web pages, or other information from files, databases, etc.
Free Form—without restrictions or preconceptions.
Vehicle Ignition—a system for igniting a fuel-air mixture.

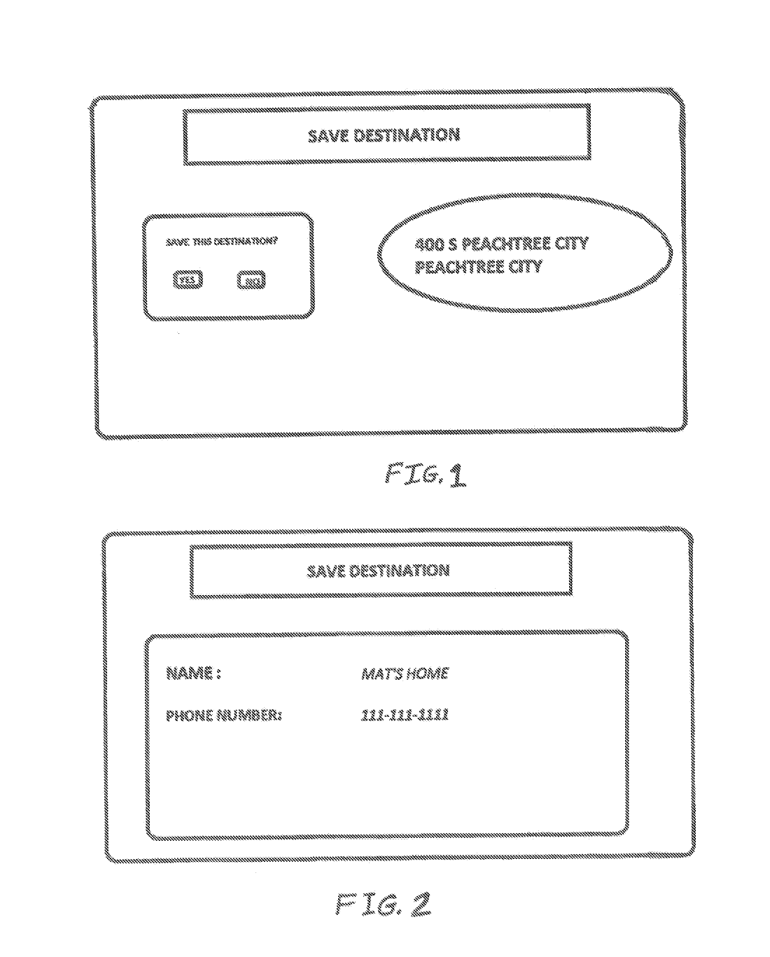

FIG. 1 illustrates one embodiment of a user interface in one step of a navigation method of the present invention in which the user is presented with the option of saving the destination. After entering a destination address the user may be presented with an interface to store the destination with a personalized name and phone number. The user may be able to edit the entry and save it after completing the edit. FIG. 1 below shows a way of saving the destination by keyboard entry. Additionally, the user may be able to save the destination using voice inputs and may later retrieve the destination using the voice input with names/phone numbers.

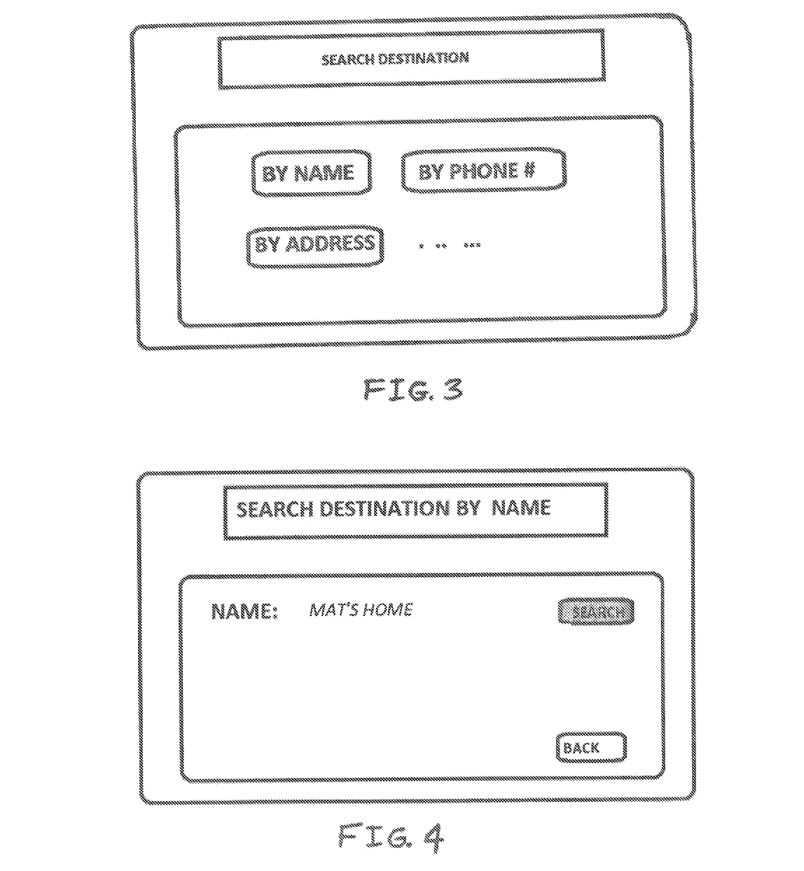

As illustrated in FIG. 2, the user may save a destination in association with a personalized name and phone number. The user may be able to search a database for the destination by use of the associated name as a search term. This feature can also be implemented via a voice recognition feature wherein the user can search for a destination by name or by phone number using voice inputs. FIG. 3 illustrates search options wherein the user may search the database by name, phone number, or address. FIG. 4 illustrates an example of a next screen in the process wherein the user has elected to search for the destination by name. FIG. 5 illustrates yet another display screen of the process whereby the user may search for a destination by a result of a previous search. As shown in FIG. 5, Mat's home address may be displayed in association with the name, “MAT'S HOME”.

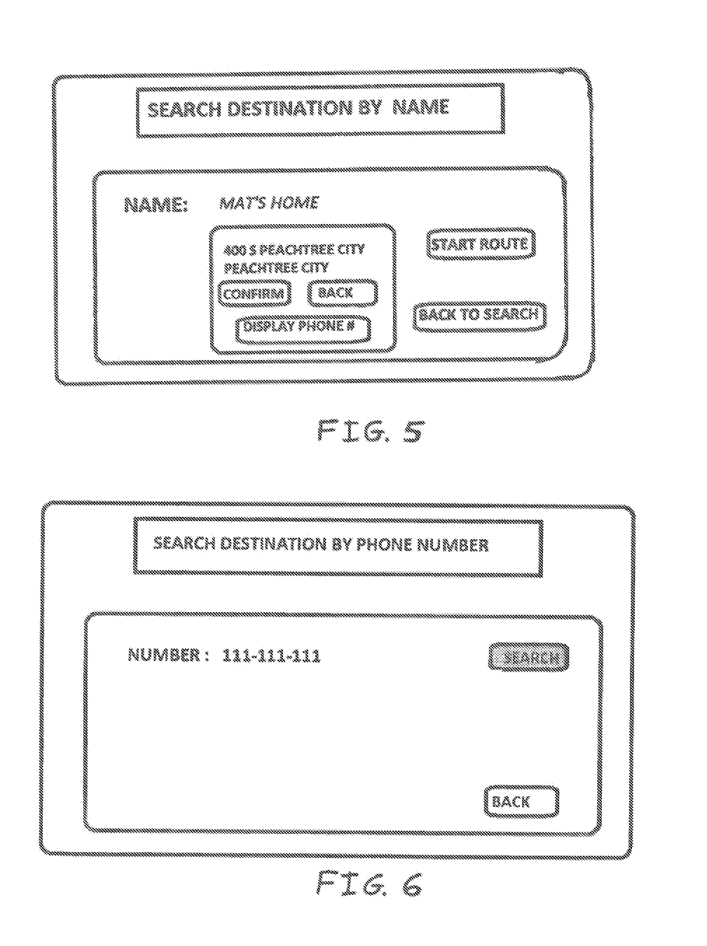

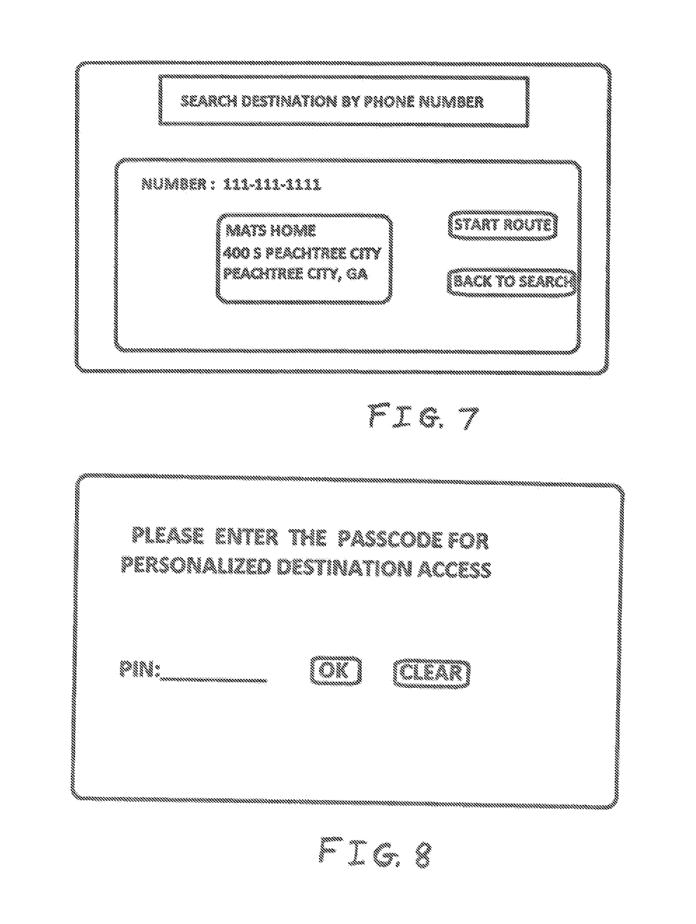

Referring now back to FIG. 3, the user may search for a destination by a personalized phone number. FIG. 6 illustrates an example of a next screen in the process wherein the user has elected to search for the destination by phone number. FIG. 7 illustrates yet another display screen of the process whereby the user may search for a destination by a phone number result of a previous search. As shown in FIG. 7, Mat's home address may be displayed in association with the phone number, “111-111-1111”.

The present invention may also include the use of password protection. A personalized destination may be password protected in order to ensure that an intruder to the car, or another user of the car, does not gain access to the personalized destinations in the system. Upon starting the navigation system after an ignition “ON”, there may be password verification. There also may optionally be password protection while a user is trying to retrieve a stored personalized destination. FIG. 8 illustrates an example display screen of a user interface in an embodiment in which password protection is used for personalized destination entry.

The present invention may include the use of different user modes for various users who may use the navigation system. An additional option for personalizing the system for more than one user is possible, wherein each user may have his own personalized saved destinations. The system may have multiple user modes. Each user mode can have an associated user name along with a personalized identification number or PIN so that the user can name any destination independently of the name given to the same destination by another user in the system.

When a user enters his user name and password, the navigation system may enable the user to access, modify, and add only his personalized destinations. Additionally, the time stamp of the last visit can be stored with a particular destination entry, and additional features can be presented to search for a destination based on the time of the visit. As an example, the user may search a destination based on a criterion such as “the shop that I went to around 2:00 pm last Saturday”. The system may save a category of the destination (e.g., “shop”) by performing an Internet search for the address, name or telephone number of the destination, and by determining from the search results (e.g., by scanning for keywords in the websites in the search results) that the destination is a “shop”. Other destination categories may include “restaurant”, “public park”, “entertainment venue”, “parking garage” and “doctor's office”, for example. In order to answer the search request “the shop that I went to around 2:00 pm last Saturday”, the system may search for the destination in the “shop” category that was visited closest to 2:00 pm on the previous Saturday.

As described above, the invention may enable categorization of personalized destinations. The user may be provided with a user interface wherein he can add a new category of destinations and a destination can be saved in association with one of the categories. Further examples of such categories may be “Friends”, “My hospitals”, “Real estate agencies”, or “Weekend classes”. Thus, the invention may enable a user to personalize the navigation system with categories that are specific to, or related to, his profession and/or interests. The user can also be enabled to store a destination address in a particular personalized category without a destination name. For example, the user may store a shop's address in association with the category “Shops to go back to”. The user may later view all the shops' addresses and phone numbers in this category, or search in a category with a time of a last visit.

The present invention may enable a map to be displayed. The user can be enabled to display a map of entries in a particular category or of all his personalized destinations. For example, the user may command the system to “Display all the saved real estate agencies on my way to destination on the map”. More generally, each of the saved real estate agencies may be marked on the map only in response to determining that the saved real estate agency is within a threshold distance of a planned route of the vehicle as programmed in the navigation system.

The invention may enable the updating of phone numbers with information received from the internet. If the navigation system has the ability to find the phone number associated with an address upon the user entering the complete address into the system, then the phone number may be presented to the user after the destination has been entered into the system. If the navigation system is able to access Google maps or any related or similar resource by use of a browser feature in the system, then there may be found published phone numbers associated. with the destinations. For example, if a store address is entered by the user, then the navigation system can present the user with the store's phone numbers, which the user may store in the system in association with the address.

As an example, on a particular day, the user may go to six different addresses and visit a different person at each address. The addresses may be determined via a GPS on the vehicle, and the addresses may be stored in association with the time, including the day, at which the vehicle's visits to the addresses occurred, On another day, the user may retrieve the addresses based on the names of the people visited at the addresses, or based on the times at which the addresses were visited.

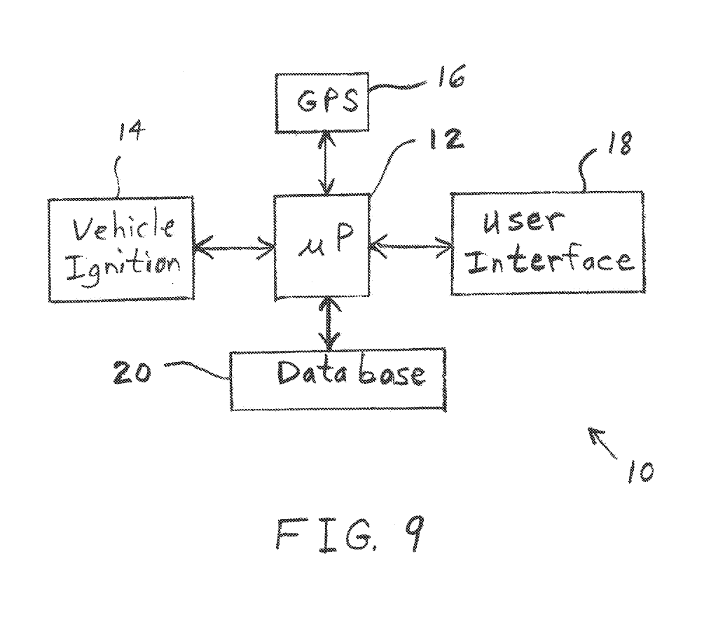

One embodiment of a motor vehicle 10 of the invention is illustrated in FIG. 9, including a processor 12, a vehicle ignition system 14, a global positioning system 16, a user interface 18, and a navigation system database 20. Processor 12 may be in bi-directional communication with each of the other four components, as indicated by the double arrows in FIG. 9. During use, database 20 may store names and telephone numbers in association with addresses. GPS 16 may detect when vehicle 10 is located at an address, and database 20 may store the times, including the days, that vehicle 10 is disposed at each address in database 20.

Database 20 may store a separate set of addresses and associated information for each of a plurality of users of vehicle 10, and each user may have access to only his set of addresses. In order to protect the security of each user's set of addresses and associated information, each time ignition 14 is turned off, the user's identity may need to be verified before processor 12 again allows the user to have access to his set of addresses. For example, the user may be required to enter a password or be biometrically identified via user interface 18 in order to gain access to his addresses, telephone numbers, names, etc. in database 20.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A method of operating a vehicle navigation system, comprising the steps of:
storing in the system a destination address in association with a name and/or telephone number; and
enabling the user to later retrieve the destination address based on the name and/or telephone number being used as a search term.

2. The method of claim 1, wherein the user is enabled to enter the name and/or telephone number free form and without format restrictions.

3. The method of claim 1, wherein the user is enabled to retrieve the destination address via a voice command.

4. The method of claim 1, wherein the name is the name of a person.

5. The method of claim 1, wherein the name is the name of a business associated with the destination address.

6. The method of claim 1, wherein the name is the name of a building located at the destination address.

7. The method of claim 1, wherein the name is a nickname designated by the user.

8. The method of claim 1, wherein the user is enabled to later retrieve the destination address by using the name or telephone number as a search term.

9. The method of claim 1, wherein, after a vehicle ignition has been turned off, the user is enabled to retrieve a destination address that was entered before the vehicle ignition was turned off only by entering a password.

10. The method of claim 1, wherein the user is enabled to later retrieve the destination address based on the name being used as a search term, and then is enabled to retrieve the telephone number based on the retrieved destination address being used as a search term.

11. The method of claim 1, wherein the user is enabled to later retrieve the telephone number based on the name being used as a search term, and then is enabled to retrieve the destination address based on the retrieved telephone number being used as a search term.

12. The method of claim 1, further comprising enabling a user to enter the destination address in association with the name and/or the telephone number.

13. The method of claim 1, further comprising:
storing in the system the destination address in association with a time at which the destination address has been visited by the vehicle; and
enabling a user to later retrieve the destination address based on the time being used as a search term.

14. The method of claim 13, further comprising:
storing in the system the destination address in association with a category of the destination; and
enabling a user to later retrieve the destination address based on the category of the destination and an approximate time at which the destination was visited.

15. The method of claim 1, further comprising:
storing in the system the destination address in association with a category of the destination; and
responding to a user request specifying the category by marking the associated destination address on a map on a display screen of a user interface of the system.

16. The method of claim 15, wherein the associated destination address is marked on the map only in response to determining that the destination address is within a threshold distance of a planned route of the vehicle programmed in the navigation system.

17. A method of operating a vehicle navigation system database, comprising the steps of:
storing in the system database three elements in association with each other, the three elements including a destination address, a name and a telephone number; and
enabling the user to later retrieve any two of the three elements by using the third of the three elements as a search term.

18. The method of claim 17, further comprising enabling a user to enter the three elements in association with each other.

19. The method of claim 17, further comprising automatically retrieving at least one of the three elements from the Internet by using at least one of the other elements as an Internet search term.

20. A motor vehicle, comprising the steps of:
an engine ignition;
a navigation system database;
a user interface; and
a processor communicatively coupled to each of the engine ignition, the navigation system database, and the user interface, the processor being configured to:
store in the system database four elements in association with each other, the four elements including a destination address, a name of the destination or of a person located at the destination, a telephone number, and an identity of a user; and
enable the user, via the user interface, to later retrieve any two of a group of three of the elements including the destination address, the name, and the telephone number by using the third of the three elements as a search term, wherein the user must have his identity verified after the vehicle ignition has been turned off before the user is enabled to retrieve any of the three elements.

21. The vehicle of claim 20, wherein the processor is configured to verify the user's identity by recognizing a password entered by the user into the user interface.

22. The vehicle of claim 20, wherein the processor is configured to enable the user, via the user interface, to enter and store in the system database the four elements in association with each other.
